(19) United States
(12) Patent Application Publication
(10) Pub. No.: US 2013/0272192 A1
(43) Pub. Date: Oct. 17, 2013

(54) Apparatuses and Methods for Hybrid Automatic Repeat Request (HARQ) Buffering Optimization

(71) Applicants: Chiao-Chih Chang, Hsinchu City (CN); Chia-Ping Chen, Hsinchu City (TW); Xiaodong Wang, Linyi (CN)

(72) Inventors: Chiao-Chih Chang, Hsinchu City (CN); Chia-Ping Chen, Hsinchu City (TW); Xiaodong Wang, Linyi (CN)

(73) Assignee: Mediatek Inc.

(21) Appl. No.: 13/379,388

(22) PCT Filed: Jan. 7, 2011
(86) PCT No.: PCT/CN11/70080

§ 371 Date: Dec. 20, 2011

(51) Int. Cl. H04W 24/02

(52) U.S. Cl. CPC H04W 24/02
USPC 370/328

(57) ABSTRACT

A wireless communications device is provided with a first cache unit coupled to a memory unit, a wireless communications module, and a hybrid automatic repeat request (HARQ) combine component coupled to the first cache unit. The wireless communications module receives from a cellular network a wireless signal carrying first data corresponding to an HARQ process. The HARQ combine component reads second data corresponding to the HARQ process from the memory unit into the first cache unit, and combines the first data and the second data for an HARQ combining procedure.

### TECHNICAL FIELD

The invention relates generally to the hybrid automatic repeat request (HARQ) mechanism, and more particularly, to HARQ buffering control for reducing the HARQ buffer required during bit-rate processing.

### BACKGROUND

For downlink packet data transmission in a wireless communications system, a user equipment (UE) is assigned a downlink shared channel from a UMTS (abbreviation for Universal Mobile Telecommunications System) Terrestrial Radio Access Network (UTRAN). The wireless technology utilized in the wireless communication system, as will be described below, includes Wideband Code Division Multiple Access (WCDMA), Time Division—Synchronous Code Division Multiple Access (TD-SCDMA), Long Term Evolution (LTE), and Worldwide Interoperability for Microwave Access (WiMAX) technology, etc. Upon reception of the downlink packet data, the UE determines whether the reception is successful, and if errors are detected in the packet data, the UE requests for retransmission by a Hybrid Automatic Repeat Request (HARQ) mechanism. The HARQ mechanism is a retransmission scheme for requesting retransmission of an error-detected packet data to ensure the delivery of the packet data. For uplink packet data transmission, a UE is assigned an uplink shared channel from a UTRAN. For the case where reception of the downlink packet data is successful, the UE transmits an acknowledgement (ACK) to the UTRAN via the uplink shared channel. Otherwise, for the case where errors are detected in the downlink packet data, the UE transmits a negative acknowledgement (NACK) to the UTRAN via the uplink shared channel. With the received ACK or NACK from the UE, the UTRAN can determine if the downlink packet data has been successfully delivered, and if so, then continue with subsequent downlink packet data transmission, or if not so, then continue with retransmission of the NACK-ed downlink packet data.

Take a TD-SCDMA system for example. A High Speed-Downlink Shared CHannel (HS-DSCH) is mapped to a newly introduced High Speed-Shared Control CHannel (HS-SCCH) and High Speed-Physical Downlink Shared CHannel (HS-PDSCH) in a physical layer. The HS-PDSCH channel is shared by a plurality of users in a cell in a time division or code division manner. The TTI (Transmission Time Interval) of the HS-PDSCH is 5 ms. The HS-PDSCH carries service data of users, while associated control information for the reception operation on the HS-PDSCH is transmitted via the HS-SCCH. For the uplink direction, the High Speed-Shared Information CHannel (HS-SICH) in the physical layer serves to transmit the uplink feedback information. The HS-PDSCH, HS-SCCH, and HS-SICH constitute a physical layer closed loop, which conducts processing and transmission in the unit of TTI of 5 ms. This shorter TTI can be better adapted to the time varying characteristic of radio links. The control information carried in the HS-SCCH channel comprises HS-PDSCH configuration, HARQ Process ID, redundant versions, new data identification, HS-SCCH cyclic sequence numbers (HCSN), UE ID, modulation form (MF), transmission block size identification, and physical channel resource information. The feedback information carried in the HS-SICH channel comprises recommended modulation form (RMF), recommended transmission blocks size (RTBS), and ACK/NAK information indicating whether data is correctly delivered or not.

FIG. 1 shows an exemplary timing diagram for the HS-SCCH and HS-PDSCH receptions in a UE. In this example, the control information carried in the HS-SCCH is received at time slot (TS)-6 of subframe n, and the HS-PDSCH configuration in the control information indicates that there are 3 TS between the HS-SCCH reception and the first TS of the forthcoming HS-PDSCH reception. As shown in FIG. 1, the user data carried in the HS-PDSCH is received starting at TS-2 and ending at TS-3 of subframe n+1. Note that during the time interval of 3 TS, the UE has to complete the decoding of the control information carried in the HS-SCCH, so that the UE may perform the HS-PDSCH reception according to the control information. FIG. 2 shows an exemplary timing diagram for the HS-PDSCH reception and HS-SICH transmission in a UE. For a TD-SCDMA system in Time-division duplexing (TDD) mode, the relationship between the HS-SCCH and the HS-SICH is predefined and is not signaled dynamically on the HS-SCCH. In this example, the user data carried in the HS-PDSCH is received at TS-6 of subframe n, and the time interval between the last TS of the HS-PDSCH reception and the first TS of the HS-SICH transmission associated with this HS-PDSCH reception is 9 TS long. Note that during the time interval of 9 TS, the UE has to complete the decoding and cyclic redundancy checking (CRC) of the user data carried in the HS-PDSCH, so that the UE may accordingly generate ACK/NACK information and other feedback information to be transmitted at TS-1 of subframe n+2.

### SUMMARY

In light of the previously described problems, there exists a need for an HARQ buffering architecture and HARQ buffering method for reducing the cost for HARQ buffering in wireless communications devices.

One aspect of the invention discloses a wireless communications device, comprising a first cache unit, a wireless communications module, and a hybrid automatic repeat request (HARQ) combine component. The first cache unit is coupled to a memory unit. The wireless communications module receives from a cellular network a wireless signal carrying first data corresponding to an HARQ process. The HARQ combine component is coupled to the first cache unit and configured to read second data corresponding to the HARQ process from the memory unit into the first cache unit, and combine the first data and the second data for an HARQ combining procedure.

Another aspect of the invention discloses another wireless communications device, comprising a first cache unit, a wireless communications module, and an HARQ combine component. The first cache unit is coupled to a memory unit. The wireless communications module receives from a cellular network a wireless signal carrying first data corresponding to an HARQ process. The HARQ combine component is coupled to the first cache unit and configured to write the data to the memory unit via the cache unit.

Another aspect of the invention discloses a method for HARQ buffering optimization in a wireless communications device. The method comprises the steps of receiving from a cellular network a wireless signal carrying first data corresponding to an HARQ process, reading second data corresponding to the HARQ process from an off-chip or off-die memory unit into a first cache unit, and combining the first data and the second data for an HARQ combining procedure.

### BRIEF DESCRIPTION OF DRAWINGS

The invention can be more fully understood by reading the subsequent detailed description and examples with references made to the accompanying drawings, wherein:

FIG. 1 shows an exemplary timing diagram for the HS-SCCH and HS-PDSCH receptions in a UE;

FIG. 2 shows an exemplary timing diagram for the HS-PDSCH reception and HS-SICH transmission in a UE;

FIG. 3 is a block diagram illustrating the architecture of BRP on HS-DSCH receptions;

FIG. 4 is a block diagram illustrating the HARQ memory of the BRP architecture in FIG. 3;

FIG. 5 shows a block diagram illustrating a single-cached HARQ buffering architecture of BRP for a wireless communications device according to an embodiment of the invention;

FIG. 6 is a timing diagram illustrating exemplary BRP according to the single-cached HARQ buffering architecture of FIG. 5;

FIG. 7 shows a block diagram illustrating a double-cached HARQ buffering architecture of BRP for a wireless communications device according to an embodiment of the invention;

FIG. 8 shows a block diagram illustrating the switching devices for managing the connections to and from the HARQ caches in FIG. 7;

FIG. 9A shows a diagram illustrating a switching device implemented by a single-pole double-thrown (SPDT) switch in accordance with an embodiment of the invention;

FIG. 9B shows a diagram illustrating a switching device implemented by a double-pole double-thrown (DPDT) switch in accordance with an embodiment of the invention;

FIG. 10 is a timing diagram illustrating exemplary BRP according to the double-cached HARQ buffering architecture of FIG. 7;

FIG. 11 shows a block diagram illustrating a single-cached and internally punctured HARQ buffering architecture of BRP for a wireless communications device according to an embodiment of the invention;

FIG. 12 shows a block diagram illustrating a single-cached and externally punctured HARQ buffering architecture of BRP for a wireless communications device according to an embodiment of the invention;

FIG. 13A shows an exemplary diagram illustrating the BRP of a first transmission of user data corresponding to one HARQ process with respect to the single-cached and externally punctured HARQ buffering architecture in FIG. 12;

FIG. 13B shows an exemplary diagram illustrating the BRP of retransmission of user data corresponding to one HARQ process with respect to the single-cached and externally punctured HARQ buffering architecture in FIG. 12;

FIG. 13C shows another exemplary diagram illustrating the BRP of retransmission of user data corresponding to one HARQ process with respect to the single-cached and externally punctured HARQ buffering architecture in FIG. 12;

FIG. 14 shows a block diagram illustrating a double-cached and externally punctured HARQ buffering architecture of BRP for a wireless communications device according to an embodiment of the invention;

FIG. 15 shows a block diagram illustrating another double-cached and externally punctured HARQ buffering architecture of BRP for a wireless communications device according to an embodiment of the invention;

FIG. 16 shows a flow chart illustrating an HARQ buffering method utilized for the single-cached HARQ buffering architecture in FIG. 5; and

FIG. 17 shows a flow chart illustrating an HARQ buffering method utilized for the double-cached HARQ buffering architecture in FIG. 7.

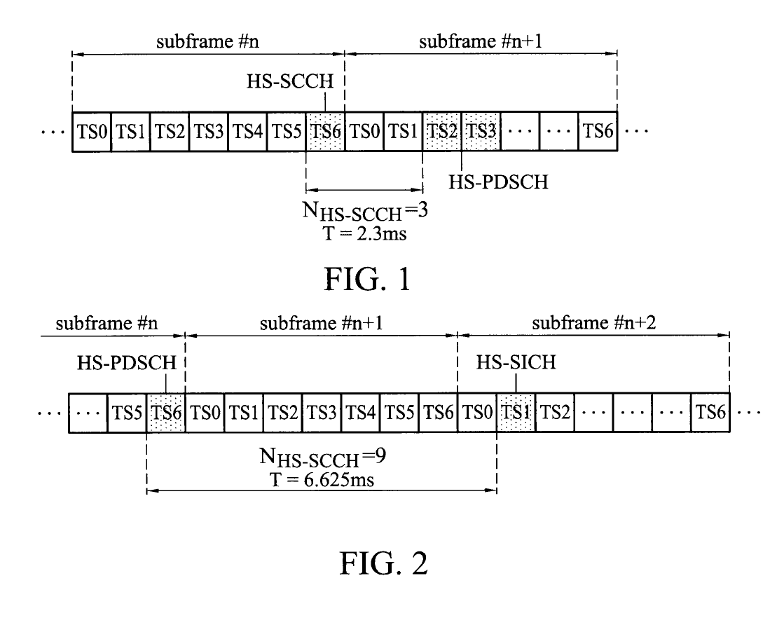

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

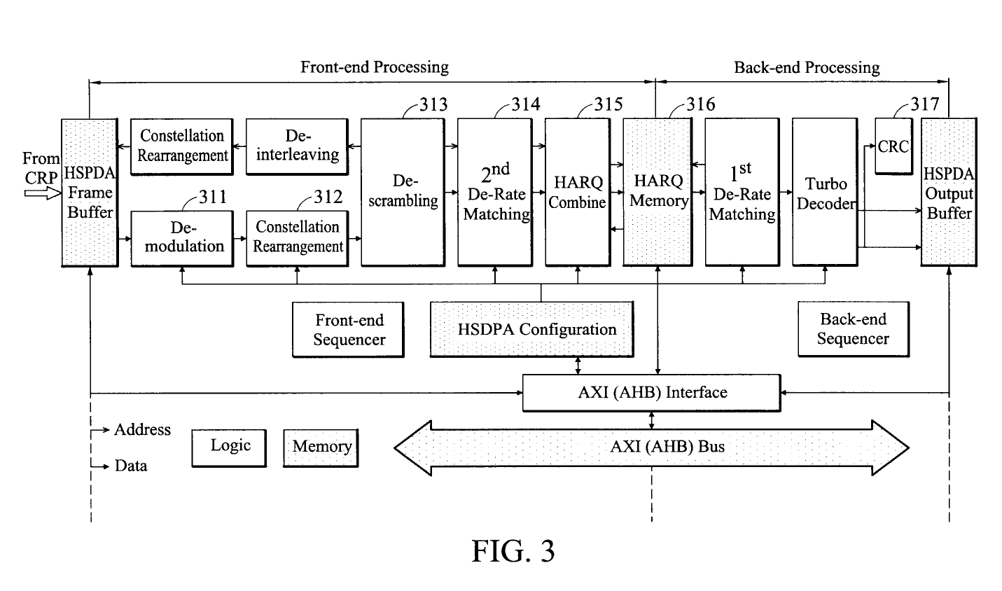

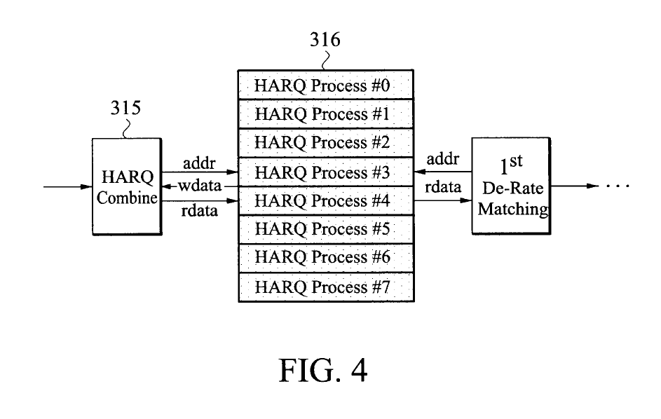

FIG. 3 is a block diagram illustrating the architecture for bit-rate processing (BRP) on High Speed-Downlink Shared CHannel (HS-DSCH) receptions. During front-end processing, the received user data is de-modulated 311, constellation rearranged 312, descrambled 313, and de-punctured 314, prior to the Hybrid Automatic Repeat Request (HARQ) combining procedure 315. For the case where the current reception is a first transmission of user data corresponding to a specific HARQ process from the UMTS (abbreviation for Universal Mobile Telecommunications System) Terrestrial Radio Access Network (UTRAN), the HARQ combining procedure 315 is skipped for the current reception in the UE and the front-end processed data of the current reception is stored into the HARQ memory 316 for back-end processing. Specifically, the user data of the current reception is stored in a space corresponding to the specific HARQ process in the HARQ memory 316, which is a on-chip memory, as shown in FIG. 4, wherein the specific HARQ process is determined according to the High Speed Downlink Packet Access (HSDPA) configuration obtained from the control information on the High Speed-Shared Control CHannel (HS-SCCH) channel. After back-end processing of HARQ memory data of current reception, if the cyclic redundancy check (CRC) procedure 317 of back-end processed data is successful, the current reception is considered as being successfully received and an acknowledgement (ACK) is later replied to the UTRAN. Otherwise, if the CRC procedure 317 of back-end processed data fails, the user data is considered as not being successfully received and a negative acknowledgement (NACK) is later replied to the UTRAN. The data stored in the HARQ memory 316 of this failed HARQ process (after front-end processing) will be used for HARQ combining for retransmission in the future to enhance receiving performance. For the case where the current reception is a retransmission of a previous unsuccessful delivery of user data corresponding to a specific HARQ process from the UTRAN, the user data of the last reception corresponding to the specific HARQ process is read out from the HARQ memory 316, and then the HARQ combining procedure 315 is performed to combine the user data of the last and current receptions corresponding to the specific HARQ process to generate combined front-end processed data and to write the combined front-end processed data to the HARQ memory 316. After back-end processing of the combined front-end processed data of the current HARQ Process ID, if the cyclic redundancy check (CRC) procedure 317 of the back-end processed data is successful, the current reception is considered as being successfully received and an acknowledgement (ACK) is later replied to the UTRAN. Otherwise, if the CRC procedure 317 fails, the current reception is considered as not being successfully received and a negative acknowledgement (NACK) is later replied to the UTRAN. Note that the size of the HARQ memory 316 may be determined according to the total number of HARQ processes configured for the High Speed-Downlink Shared CHannel (HS-DSCH). For example, the maximum number of HARQ processes is 8 in the Time Division—Synchronous Code Division Multiple Access (TD-SCDMA) system. However, often less 8 HARQ processes are active in each HS-DSCH Transmission Time Interval (TTI). Thus, it is desirable to have more efficient designs for HARQ buffering.

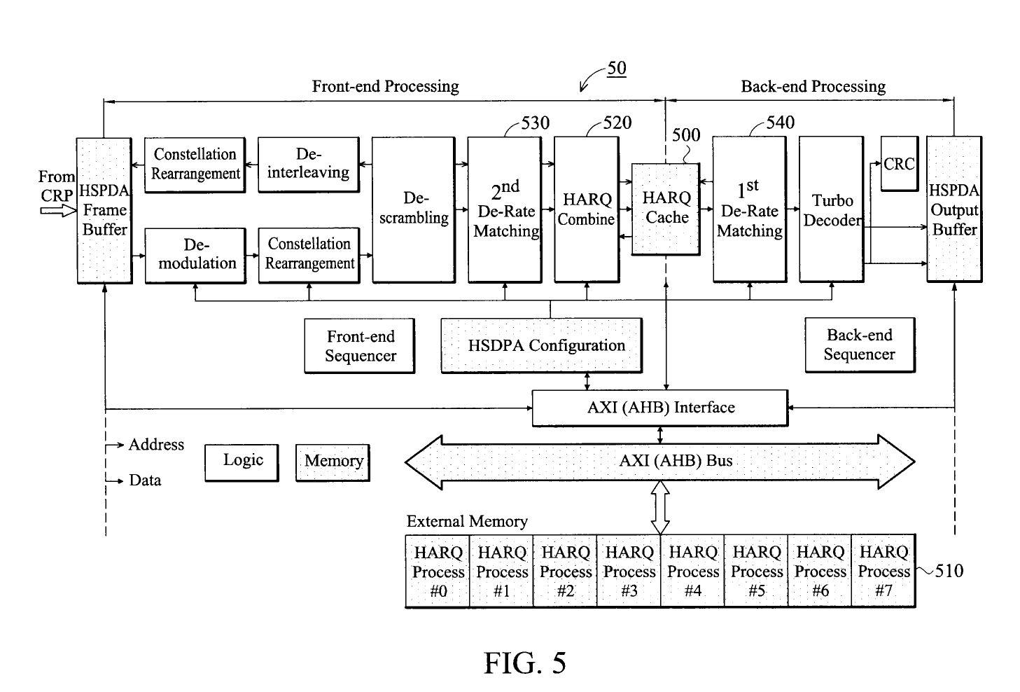

FIG. 5 shows a block diagram illustrating a single-cached HARQ buffering architecture 50 of BRP for a wireless communications device according to an embodiment of the invention. In this embodiment, the wireless communications device may be a UE capable of communicating with a UTRAN according to the HARQ mechanism. As shown in FIG. 5, an HARQ cache 500 is employed for buffering front-end processed data of the current HARQ process. In addition, an external memory 510 is coupled to the HARQ cache 500 via the Advanced eXtensible Interface (AXI) bus, wherein the external memory 510 is further partitioned into N separate spaces, denoted as HARQ process #0˜#N−1, for the HARQ processes configured for the HS-DSCH. Those skilled in the art may transceiver data between the HARQ cache 500 and the external memory 510 via other bus architecture, and the invention should not be limited thereto. The number of HARQ processes may be configured to be an integer from 1 to 8 according to the “HARQ info” Information Element (IE) indicated by the UTRAN. Specifically, for the case where the current High Speed-Physical Downlink Shared CHannel (HS-PDSCH) reception is a retransmission of a previous unsuccessful delivery of user data corresponding to a specific HARQ process from the UTRAN, the HARQ cache 500 is configured to read in the last HS-PDSCH reception of the front-end processed data corresponding to the specific HARQ process from the external memory 510 for the HARQ combining procedure 520. After back-end processing of the combined front-end processed data of current HARQ Process ID, if the CRC procedure on the back-end processed data fails, the HARQ cache 500 is further configured to write the combined front-end processed data to the external memory 510. For the case where the current HS-PDSCH reception is a first transmission of user data corresponding to a specific HARQ process from the UTRAN, the HARQ combining procedure 520 is skipped, and the front-end processed data is written into the HARQ cache 500. After back-end processing of the front-end processed data, if the CRC procedure on the back-end processed data fails, the HARQ cache 500 is configured to write the front-end processed data to the external memory 510. Note that the size of the HARQ cache 500 equals to that of data corresponding to one HARQ process, which greatly reduces the cost of HARQ buffering. While in other embodiments, the size of the HARQ cache 500 may equal to that of data corresponding to more than one HARQ process. Regarding the detailed descriptions of the functional components shown in FIG. 5, such as “De-modulation”, “Constellation Rearrangement”, “De-interleaving”, “De-scrambling”, “2^{nd} De-Rate Matching”, “HARQ Combine”, “1^{st} De-Rate Matching”, “Turbo Decoder”, “CRC”, “Front-end Sequencer”, and “Back-end Sequencer”, references may be made to the 3GPP TS 25.221 specification. The above mentioned functional components may be implemented with program codes which is stored in another memory (not shown) or a storage device (not shown), and is loaded and executed by a processing unit, such as a general-purposed processor or a micro-control unit (MCU), or others, to provide the specific functionalities. In addition to the functional components shown in FIG. 5, the wireless communications device may further comprise a wireless communications module (not shown) for receiving wireless signals which carry the HS-SCCH and HS-PDSCH associated data from the UTRAN, and transmitting wireless signals which carry the High Speed-Shared Information CHannel (HS-SICH) associated data to the UTRAN. To further clarify, the wireless communications module (not shown) may comprise a baseband unit (not shown) and a radio frequency (RF) unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications system, wherein the radio frequency may be 900 MHz, 1900 MHz or 2100 MHz utilized in the WCDMA systems, or may be 2010 MHz to 2025 MHz utilized in the TD-SCDMA systems, or others depending on the radio access technology (RAT) in use.

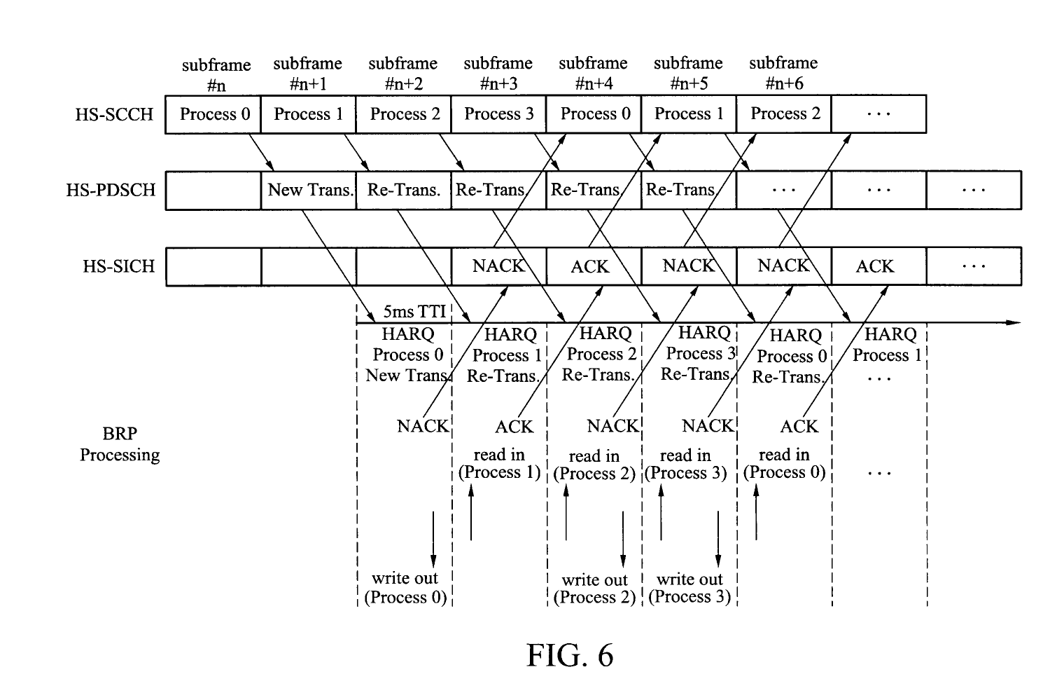

FIG. 6 is a timing diagram illustrating exemplary BRP according to the single-cached HARQ buffering architecture of FIG. 5. For the HARQ process #0, the control information for a first transmission of user data is transmitted in the HS-SCCH at subframe n, and the first transmission of user data is transmitted in the HS-PDSCH at subframe n+1. The UE receives and performs BRP for the first transmission of user data corresponding to the HARQ process #0 at subframe n+2. During BRP at subframe n+2, the CRC procedure on the user data is performed. In this embodiment, as the CRC procedure on the user data fails, the HARQ cache 500 is configured to write the user data to the external memory 510 and the UE further prepares a NACK for negative acknowledgement of the delivery of the user data. At subframe n+3, the UE transmits the NACK to the UTRAN. For the HARQ process #1, the control information for a retransmission of user data is transmitted in the HS-SCCH at subframe n+1, and the retransmission of user data is transmitted in the HS-PDSCH at subframe n+2. After the control information for the retransmitted user data corresponding to the HARQ process #1 is received at subframe n+2 and the writing of user data corresponding to the HARQ process #0 is finished, the HARQ cache 500 is configured to read in the last HS-PDSCH reception of the user data corresponding to the HARQ process #1 from the external memory 510 in the early stage at subframe n+3. Later at subframe n+3, the HARQ combining procedure 520 is performed to combine the user data from the last and current HS-PDSCH receptions corresponding to the HARQ process #1 and the CRC is performed on the combined user data. In this embodiment, as the CRC procedure on the combined user data is successful, the HARQ cache 500 is not configured to perform any writing operation and the UE further prepares an ACK for acknowledging the delivery of the retransmitted user data. At subframe n+4, the UE transmits the ACK to the UTRAN.

For the HARQ process #2, the control information for a retransmission of user data is transmitted in the HS-SCCH at subframe n+2, and the retransmission of user data is transmitted in the HS-PDSCH at subframe n+3. After the control information for the retransmitted user data corresponding to the HARQ process #2 is received at subframe n+3, the HARQ cache 500 is configured to read in the last HS-PDSCH reception of the user data corresponding to the HARQ process #2 from the external memory 510 in the early stage at subframe n+4. Later at subframe n+4, the HARQ combining procedure 520 is performed to combine the user data from the last and current HS-PDSCH receptions corresponding to the HARQ process #2 and the CRC is performed on the combined user data. In this embodiment, as the CRC procedure on the combined user data fails, the HARQ cache 500 is configured to write the combined user data to the external memory 510 and the UE further prepares a NACK for negative acknowledgement of the delivery of the retransmitted user data. At subframe n+5, the UE transmits the NACK to the UTRAN. For the HARQ process #3, the control information for a retransmission of user data is transmitted in the HS-SCCH at subframe n+3, and the retransmission of user data is transmitted in the HS-PDSCH at subframe n+4. After the control information for the retransmitted user data corresponding to the HARQ process #3 is received at subframe n+4 and the writing of user data corresponding to the HARQ process #2 is finished, the HARQ cache 500 is configured to read in the last HS-PDSCH reception of the user data corresponding to the HARQ process #3 from the external memory 510 in the early stage at subframe n+5. Later at subframe n+5, the HARQ combining procedure 520 is performed to combine the user data from the last and current HS-PDSCH receptions corresponding to the HARQ process #3 and the CRC is performed on the combined user data. In this embodiment, as the CRC procedure on the combined user data fails, the HARQ cache 500 is configured to write the combined user data to the external memory 510 and the UE further prepares a NACK for negative acknowledgement of the delivery of the retransmitted user data. At subframe n+6, the UE transmits the NACK to the UTRAN. Note that the number of HARQ processes is 4 in this embodiment, so the UTRAN circles back to the transmission of user data corresponding to the HARQ process #0 after the most recent transmission of user data corresponding to the HARQ process #3 is finished. For the HARQ process #0, another retransmission of the last retransmitted user data corresponding to the HARQ process #0 is scheduled to be performed since a NACK is received for the last retransmission. The control information for another retransmission of user data is transmitted in the HS-SCCH at subframe n+4, and the retransmission of user data is transmitted in the HS-PDSCH at subframe n+5. After the control information for the retransmitted user data corresponding to the HARQ process #0 is received at subframe n+5 and the writing of user data corresponding to the HARQ process #3 is finished, the HARQ cache 500 is configured to read in the last HS-PDSCH reception of the user data corresponding to the HARQ process #0 from the external memory 510 in the early stage at subframe n+6. Later at subframe n+6, the HARQ combining procedure 520 is performed to combine the user data from the last and current HS-PDSCH receptions corresponding to the HARQ process #0 and the CRC is performed on the combined user data. In this embodiment, as the CRC procedure on the combined user data is successful, the HARQ cache 500 is not configured to perform any writing operation and the UE further prepares an ACK for acknowledging the delivery of the retransmitted user data. At subframe n+7, the UE transmits the ACK to the UTRAN.

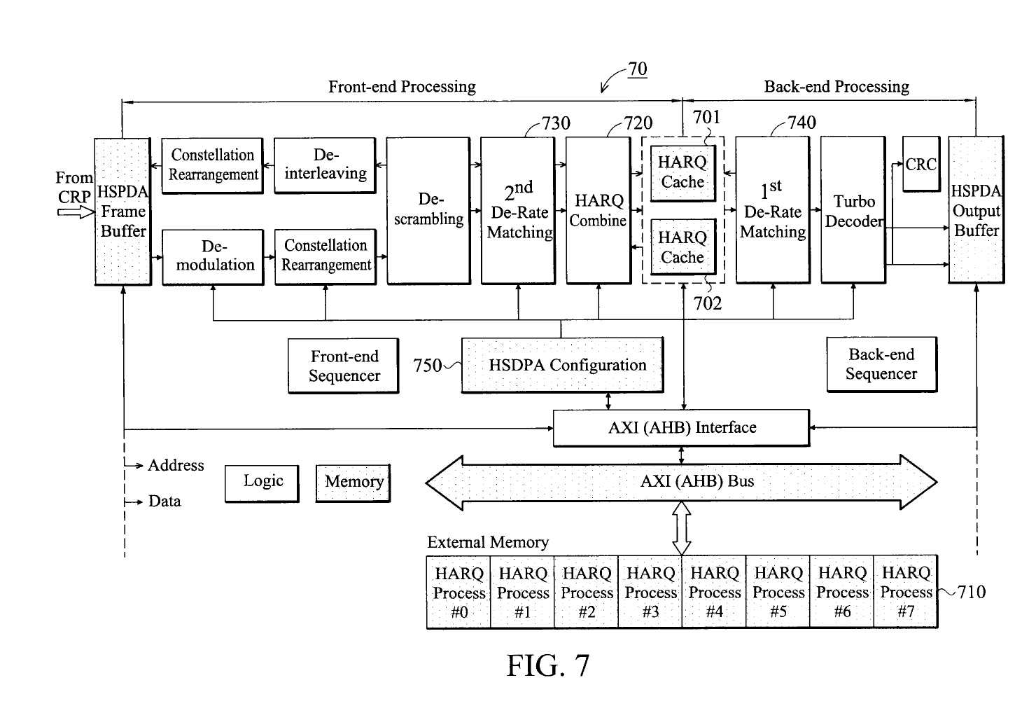

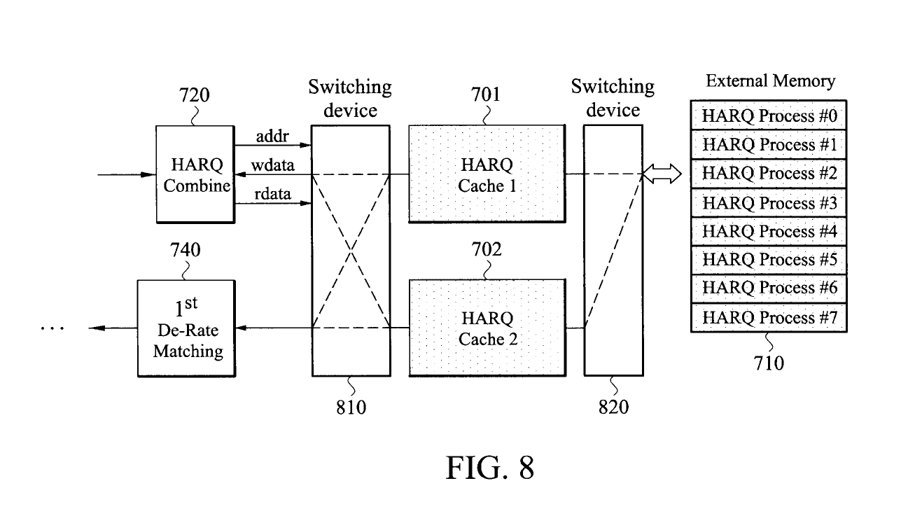

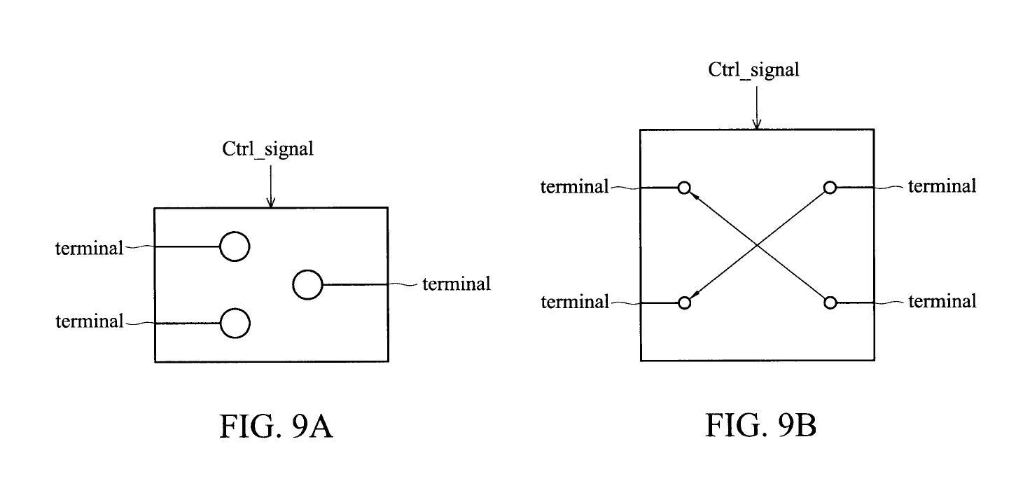

FIG. 7 shows a block diagram illustrating a double-cached HARQ buffering architecture 70 of BRP for a wireless communications device according to an embodiment of the invention. In this embodiment, the wireless communications device may be a UE capable of communicating with a UTRAN according to the HARQ mechanism. As shown in FIG. 7, two HARQ caches 701 and 702 are employed for buffering unsuccessful deliveries of user data corresponding to two HARQ processes, respectively. In addition, an external memory 710 is coupled to the HARQ caches 701 and 702 via the AXI bus, wherein the external memory 710 is further partitioned into N separate spaces, denoted as HARQ process #0˜#N−1, for the HARQ processes configured for the HS-DSCH. Those skilled in the art may transceiver data between the HARQ caches 701 and 702 and the external memory 710 via other bus architecture, and the invention should not be limited thereto. The number of HARQ processes may be configured to be an integer from 1 to 8 according to the “HARQ info” Information Element (IE) indicated by the UTRAN. Specifically, for the case where the current HS-PDSCH reception is a retransmission of a previous unsuccessful delivery of user data corresponding to the current HARQ process from the UTRAN, the HARQ cache 701 is configured to read in the user data corresponding to the current HARQ process from the last HS-PDSCH reception from the external memory 710 for the HARQ combining procedure 720. After the current HS-PDSCH reception is completed, a HARQ cache 702 is configured to write the combined user data to the external memory 710 if the CRC procedure on the combined user data fails. During the writing of the combined user data, the control information for the next HS-PDSCH reception is received. If the next HS-PDSCH reception is a retransmission of a previous unsuccessful delivery of user data corresponding to the next HARQ process from the UTRAN, the HARQ cache 701 may be configured to read in the last HS-PDSCH reception of the user data corresponding to the next HARQ process from the external memory 710 while the HARQ cache 702 is performing the writing operation. In one embodiment, the HARQ caches 701 and 702 may be configured to operate in a fixed mode or a ping-pong mode. In the fixed mode, one of the HARQ caches 701 and 702 is configured for writing operations corresponding to the current HARQ process while the other HARQ cache is configured for reading operations corresponding to the next HARQ process. In the ping-pong mode, the HARQ caches are cyclically configured to perform reading and writing operations requested by the current and next HARQ processes. Please refer to FIG. 8. Additionally, a switching device 810 may be employed to connect one of the HARQ caches 701 and 702 to one of the functional components “HARQ Combine” 720 and “1^{St} De-Rate Matching” 740, and connect the other HARQ cache to the other function component. A switching device 820 may be employed to connect one of the HARQ caches 701 and 702 to the external memory 710. Instead of employing only one switching device for the connections between the HARQ caches 701 and 702 and the functional components “HARQ Combine” 720 and “1^{st} De-Rate Matching” 740, two separate switching devices may be employed. If only one switching device is employed for the connections between the HARQ caches and the functional components “HARQ Combine” and “1^{st} De-Rate Matching”, the switching device may be implemented by a double pole double thrown (DPDT) switch, as shown in FIG. 9B. If two separate switching devices are employed for the connections between the HARQ caches and the functional components “HARQ Combine” and “1^{st} De-Rate Matching”, the switching devices may be respectively implemented by two single pole double thrown (SPDT) switches, each as shown in FIG. 9A. The control signal for controlling the connections between the terminals to each switching device may be generated according to the control information stored in “HSDPA Configuration” 750 indicating whether the current and next HS-PDSCH receptions are retransmissions or new transmissions of user data.

Thus, the double-cached design provides an efficient way for simultaneous executions of writing and reading operations corresponding to the current and next HARQ processes. Moreover, the size of each of the HARQ caches equals to that of user data corresponding to one HARQ process, which greatly reduces the cost of HARQ buffering. Those skilled in the art may replace the double-cached designed with a two-port cache or a single-port cache operating in higher clock rate, which is in a size equal to or more than 2 HARQ processes, upon reviewing the double-cached design of the invention, and the alternative design should be taken as a variation of this embodiment since it operates like the double-cached design. Similarly, regarding the detailed descriptions of the functional components shown in FIG. 7, such as “De-modulation”, “Constellation Rearrangement”, “De-interleaving”, “De-scrambling”, “2^{nd} De-Rate Matching”, “HARQ Combine”, “1^{st} De-Rate Matching”, “Turbo Decoder”, “CRC”, “Front-end Sequencer”, and “Back-end Sequencer”, references may be made to the 3GPP TS 25.221 specification. The above mentioned functional components may be implemented with program codes which is stored in another memory (not shown) or a storage device (not shown), and is loaded and executed by a processing unit, such as a general-purposed processor or a micro-control unit (MCU), or others, to provide the specific functionalities. In addition to the functional components shown in FIG. 7, the wireless communications device may further comprise a wireless communications module (not shown) for receiving wireless signals which carry the HS-SCCH and HS-PDSCH associated data from the UTRAN, and transmitting wireless signals which carry the HS-SICH associated data to the UTRAN, as described above with respect to FIG. 5.

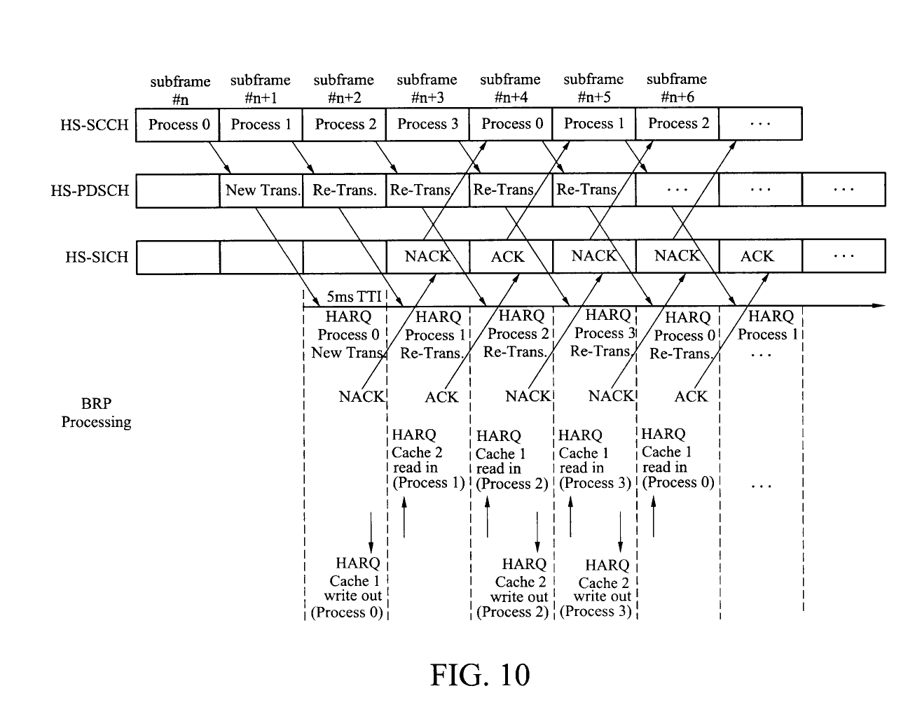

FIG. 10 is a timing diagram illustrating exemplary BRP according to the double-cached HARQ buffering architecture of FIG. 7. For the HARQ process #0, the control information for a first transmission of user data is transmitted in the HS-SCCH at subframe n, and the first transmission of user data is transmitted in the HS-PDSCH at subframe n+1. The UE receives and performs BRP for the first transmission of user data corresponding to the HARQ process #0 at subframe n+2. During BRP at subframe n+2, the CRC procedure on the user data is performed. In this embodiment, as the CRC procedure on the user data fails, the HARQ cache 701 is configured to write the user data to the external memory 710 and the UE further prepares a NACK for negative acknowledgement of the delivery of the user data. At subframe n+3, the UE transmits the NACK to the UTRAN. For the HARQ process #1, the control information for a retransmission of user data is transmitted in the HS-SCCH at subframe n+1, and the retransmission of user data is transmitted in the HS-PDSCH at subframe n+2. After the control information for the retransmitted user data corresponding to the HARQ process #1 is received at subframe n+2, the HARQ cache 702 is configured to read in the last HS-PDSCH reception of the user data corresponding to the HARQ process #1 from the external memory in the early stage at subframe n+3, without waiting for the completion of the writing of user data corresponding to the HARQ process #0. Later at subframe n+3, the HARQ combining procedure 720 is performed to combine the user data from the last and current HS-PDSCH receptions corresponding to the HARQ process #1 and the CRC is performed on the combined user data. In this embodiment, as the CRC procedure on the combined user data is successful, the HARQ cache is not configured to perform any writing operation and the UE further prepares an ACK for acknowledging the delivery of the retransmitted user data. At subframe n+4, the UE transmits the ACK to the UTRAN. For the HARQ process #2, the control information for a retransmission of user data is transmitted in the HS-SCCH at subframe n+2, and the retransmission of user data is transmitted in the HS-PDSCH at subframe n+3. After the control information for the retransmitted user data corresponding to the HARQ process #2 is received at subframe n+3, the HARQ cache 701 is configured to read in the last HS-PDSCH reception of the user data corresponding to the HARQ process #2 from the external memory 710 in the early stage at subframe n+4. Later at subframe n+4, the HARQ combining procedure 720 is performed to combine the user data from the last and current HS-PDSCH receptions corresponding to the HARQ process #2 and the CRC is performed on the combined user data. In this embodiment, as the CRC procedure on the combined user data fails, the HARQ cache 702 is configured to write the combined user data to the external memory 710 and the UE further prepares a NACK for negative acknowledgement of the delivery of the retransmitted user data. At subframe n+5, the UE transmits the NACK to the UTRAN.

For the HARQ process #3, the control information for a retransmission of user data is transmitted in the HS-SCCH at subframe n+3, and the retransmission of user data is transmitted in the HS-PDSCH at subframe n+4. After the control information for the retransmitted user data corresponding to the HARQ process #3 is received at subframe n+4, the HARQ cache 701 is configured to read in the last HS-PDSCH reception of the user data corresponding to the HARQ process #3 from the external memory 710 in the early stage at subframe n+5, without waiting for the completion of the writing of user data corresponding to the HARQ process #2. Later at subframe n+5, the HARQ combining procedure 720 is performed to combine the user data from the last and current HS-PDSCH receptions corresponding to the HARQ process #3 and the CRC is performed on the combined user data. In this embodiment, as the CRC procedure on the combined user data fails, the HARQ cache 702 is configured to write the combined user data to the external memory 710 and the UE further prepares a NACK for negative acknowledgement of the delivery of the retransmitted user data. At subframe n+6, the UE transmits the NACK to the UTRAN. Note that the number of HARQ processes is 4 in this embodiment, so the UTRAN circles back to the transmission of user data corresponding to the HARQ process #0 after the most recent transmission of user data corresponding to the HARQ process #3 is finished. For the HARQ process #0, another retransmission of the last retransmitted user data corresponding to the HARQ process #0 is to be performed since a NACK is received for the last retransmission. The control information for another retransmission of user data is transmitted in the HS-SCCH at subframe n+4, and the retransmission of user data is transmitted in the HS-PDSCH at subframe n+5. After the control information for the retransmitted user data corresponding to the HARQ process #0 is received at subframe n+5, the HARQ cache 701 is configured to read in the last HS-PDSCH reception of the user data corresponding to the HARQ process #0 from the external memory 710 in the early stage at subframe n+6, without waiting for the completion of the writing of user data corresponding to the HARQ process #3. Later at subframe n+6, the HARQ combining procedure 720 is performed to combine the user data from the last and current HS-PDSCH receptions corresponding to the HARQ process #0 and the CRC is performed on the combined user data. In this embodiment, as the CRC procedure on the combined user data is successful, the HARQ cache is not configured to perform any writing operation and the UE further prepares an ACK for acknowledging the delivery of the retransmitted user data. At subframe n+7, the UE transmits the ACK to the UTRAN. It is to be understood that, although the ping-pong mode is employed for the operations of the HARQ caches 701 and 702 in this embodiment, the operations of the HARQ caches 701 and 702 in the fixed mode may be contemplated according to the embodiments disclosed in FIG. 7 and FIG. 10.

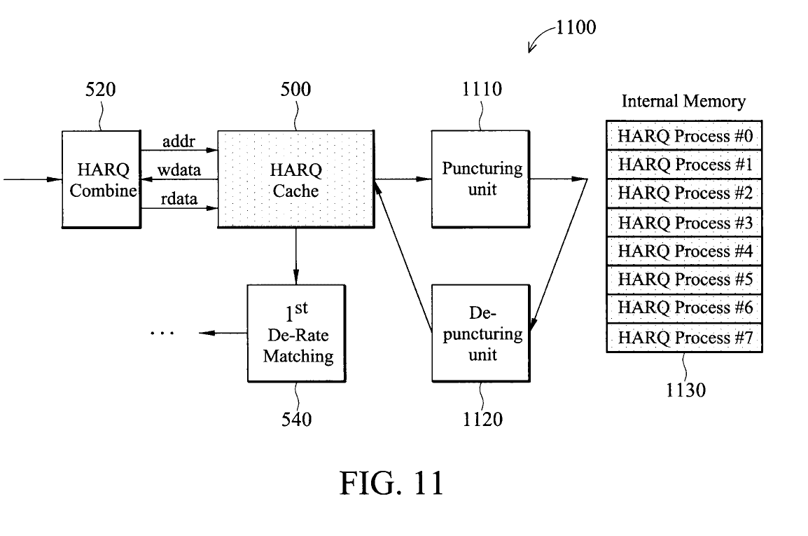

FIG. 11 shows a block diagram illustrating a single-cached and internally punctured HARQ buffering architecture for a wireless communications device according to an embodiment of the invention. In this embodiment, the wireless communications device may be a UE capable of communicating with a UTRAN according to the HARQ mechanism. Similar to FIG. 5, an HARQ buffering module 1100 is employed for buffering unsuccessful delivery of user data corresponding to the current or next HARQ process. In the HARQ buffering module 1100, an HARQ cache 500 in a size of user data corresponding to one HARQ process is used to buffer user data corresponding to the current or next HARQ process for the functional components “HARQ Combine” 520 and “1^{st} De-Rate Matching” 540. In addition, the HARQ buffering module 1100 comprises an internal memory 1130 (also called on-chip memory) which is partitioned into N separate spaces, denoted as HARQ process #0˜#N−1, for the HARQ processes configured for the HS-DSCH. The number of HARQ processes may be configured to be an integer from 1 to 8 according to the “HARQ info” Information Element (IE) indicated by the UTRAN. Between the HARQ cache 500 and the internal memory 1130, a puncturing unit 1110 and a de-puncturing unit 1120 are employed to puncture and de-puncture the unsuccessful delivery of user data to be buffered or combined. To further clarify, for the case where the current HS-PDSCH reception is a first transmission of user data corresponding to the current HARQ process from the UTRAN, the functional component “HARQ Combine” 520 performs CRC on the user data. If the CRC procedure fails, the HARQ cache 500 is configured to write the user data corresponding to the current HARQ process to the internal memory. Note that, during the writing of the user data to the internal memory 1130, the puncturing unit 1110 is configured to puncture the user data according to the de-puncturing parameters previously used in the functional component “2^{nd} De-Rate Matching” 530. That is, the puncturing step reduces the size of the user data to be stored in the internal memory 1130, which further reduces the size of the internal memory 1130 required for storing user data corresponding to every HARQ process. For the case where the current HS-PDSCH reception is a retransmission of a previous unsuccessful delivery of user data corresponding to the current HARQ process from the UTRAN, the HARQ cache 500 is configured to read in the user data corresponding to the current HARQ process from the last HS-PDSCH reception from the internal memory 1130 for the HARQ combining procedure 520. Note that, during the reading of the user data from the internal memory 1130, the de-puncturing unit 1120 is configured to de-puncture the punctured user data stored in the internal memory 1130 according to the de-puncturing parameters previously used in the functional component “2^{nd} De-Rate Matching” 530. After the reading of the user data corresponding to the current HARQ process from the last HS-PDSCH reception and the current HS-PDSCH reception are completed, the functional component “HARQ Combine” 520 combines the read and newly received user data and performs CRC on the combined user data. If the CRC procedure on the combined user data fails, the HARQ cache 500 is further configured to write the combined user data to the internal memory 1130 via the puncturing unit 1110. Note that the size of the HARQ cache 500 equals to that of user data corresponding to one HARQ process, and the size of each partition in the internal memory 1130 is smaller than that of a de-punctured user data corresponding to one HARQ process. Regarding the detailed operations of the HARQ buffering for other cases of HS-PDSCH reception, references may be made to the descriptions with respect to the FIG. 6. Alternatively, the size of the HARQ cache 500 may equal to that of data corresponding to more than one HARQ process.

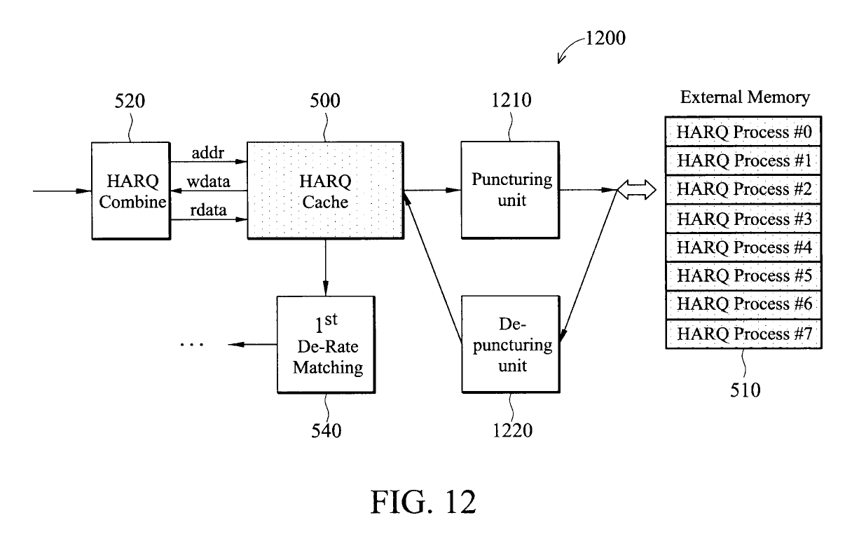

FIG. 12 shows a block diagram illustrating a single-cached and externally punctured HARQ buffering architecture for a wireless communications device according to an embodiment of the invention. In this embodiment, the wireless communications device may be a UE capable of communicating with a UTRAN according to the HARQ mechanism. Similar to FIG. 11, an HARQ buffering module 1200 is employed for buffering unsuccessful delivery of user data corresponding to the current or next HARQ process, and in the HARQ buffering module 1200, an HARQ cache 500 in a size of user data corresponding to an HARQ process is used to buffer user data corresponding to the current or next HARQ process for the functional components “HARQ Combine” 520 and “1^{st} De-Rate Matching” 540. However, in the HARQ buffering module 1200, an external memory 510 (also called off-chip or off-die memory) is coupled to the HARQ cache 500 via the AXI bus, which is partitioned into N separate spaces, denoted as HARQ process #0˜#N−1, for the HARQ processes configured for the HS-DSCH. The external memory 510 may be implemented as an off-chip memory, which is packaged in a different chip from a main chip including at least the “HARQ combine” component 315 and the HARQ cache 500. Alternatively, the external memory 510 may be implemented as an off-die memory different from a main die including at least the “HARQ combine” component 315 and the HARQ cache, where the off-die memory and the main die are packaged in a single chip (also referred to as system in a package, SIP). The number of HARQ processes may be configured to be an integer from 1 to 8 according to the “HARQ info” Information Element (IE) indicated by the UTRAN. Between the HARQ cache 500 and the external memory 510, a puncturing unit 1210 and a de-puncturing unit 1220 are employed to puncture and de-puncture the unsuccessful delivery of user data to be buffered or combined. To further clarify, for the case where the current HS-PDSCH reception is a first transmission of user data corresponding to the current HARQ process from the UTRAN, the functional component “HARQ Combine” 520 performs CRC on the user data. If the CRC procedure fails, the HARQ cache 500 is configured to write the user data corresponding to the current HARQ process to the external memory 510. Note that, during the writing of the user data to the external memory 510, the puncturing unit 1210 is configured to puncture the user data according to the de-puncturing parameters previously used in the functional component “2^{nd} De-Rate Matching” 530. That is, the puncturing step reduces the size of the user data to be stored in the external memory 510, which further reduces the size of the external memory 510 and the AXI bus bandwidth required for storing user data corresponding to every HARQ process. For the case where the current HS-PDSCH reception is a retransmission of a previous unsuccessful delivery of user data corresponding to the current HARQ process from the UTRAN, the HARQ cache 500 is configured to read in the user data corresponding to the current HARQ process from the last HS-PDSCH reception from the external memory 510 for the HARQ combining procedure. Note that, during the reading of the user data from the external memory 510, the de-puncturing unit 1220 is configured to de-puncture the punctured user data stored in the external memory 510 according to the de-puncturing parameters previously used in the functional component “2^{nd} De-Rate Matching” 530. After the reading of the user data corresponding to the current HARQ process from the last HS-PDSCH reception and the current HS-PDSCH reception are completed, the functional component “HARQ Combine” 520 combines the read and newly received user data and performs CRC on the combined user data. If the CRC procedure on the combined user data fails, the HARQ cache 500 is further configured to write the combined user data to the external memory 510 via the puncturing unit 1210. Note that the size of the HARQ cache 500 equals to that of user data corresponding to one HARQ process, and the size of each partition in the external memory 510 is smaller than that of a de-punctured user data corresponding to one HARQ process. Regarding the detailed operations of the HARQ buffering for other cases of HS-PDSCH reception, references may be made to the descriptions with respect to the FIG. 6. Alternatively, the size of the HARQ cache 500 may equal to that of data corresponding to more than one HARQ process.

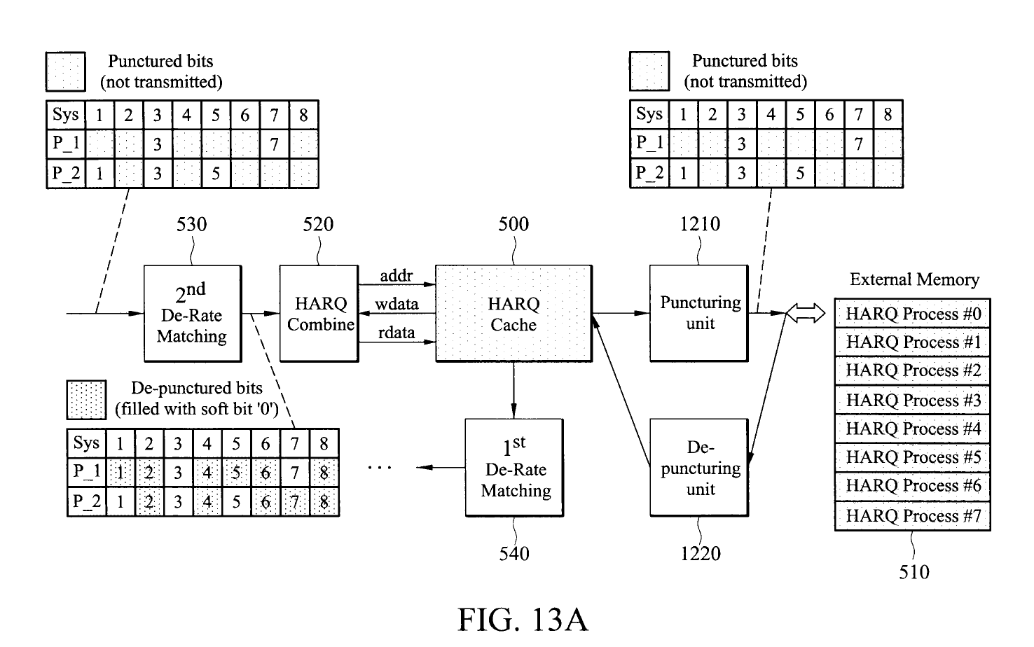

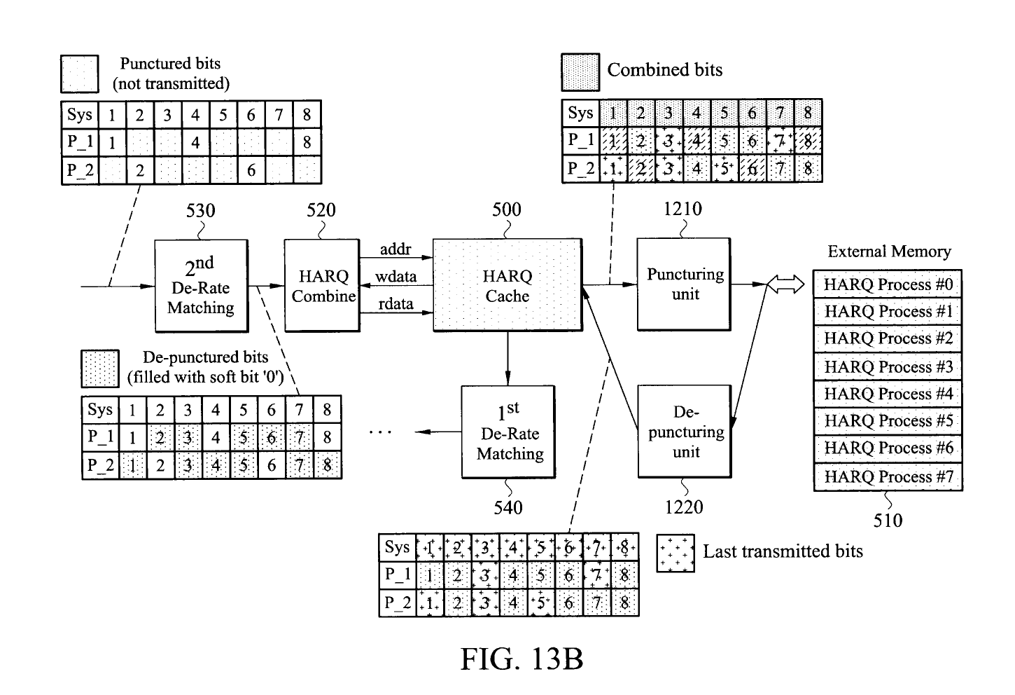

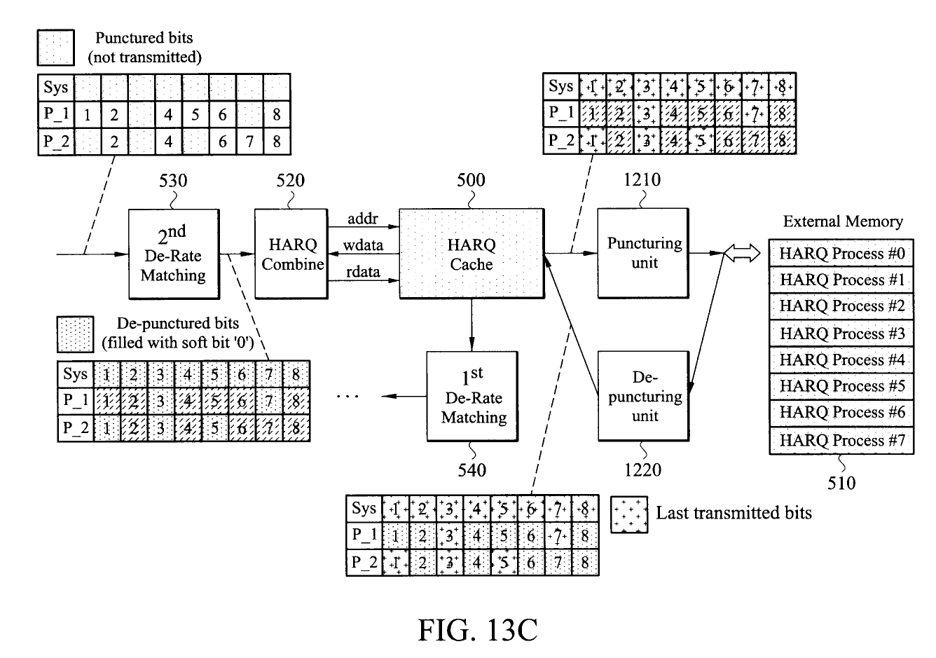

FIG. 13A shows an exemplary diagram illustrating the BRP of a first transmission of user data corresponding to one HARQ process with respect to the single-cached and externally punctured HARQ buffering architecture in FIG. 12. The current HS-PDSCH reception is a first transmission of user data corresponding to the current HARQ process from the UTRAN. After the user data is demodulated, constellation rearranged, and descrambled, the user data comprises 8 systematic bits and 2 sets of 8 parity bits, wherein some of the parity bits are punctured, as shown in FIG. 13A. Subsequently, second de-rate matching is performed and the punctured bits are therefore de-punctured, i.e., filled with soft bits of zeros. The functional component “HARQ Combine” 520 then performs CRC on the de-punctured user data, and skips the HARQ combining procedure since the user data is for a first transmission. In this embodiment, the CRC procedure on the de-punctured user data fails, and the HARQ cache 500 is configured to write out the de-punctured user data. Specifically, during the writing out of the de-punctured user data, the puncturing unit 1210 is configured to puncture the de-punctured user data, i.e., removing the soft bits of zeros filled during the 2^{nd} De-Rate Matching. Note that the puncturing unit 1210 performs the puncturing step according to the de-puncturing parameters previously used in the functional component “2^{nd} De-Rate Matching” 530. Lastly, the punctured user data is written to the corresponding partition for the current HARQ process in the external memory 510, and the BRP continues with the back-end processing for the UE to prepare a NACK for negative acknowledgement of the delivery of the user data. In another embodiment, if the CRC procedure on the de-punctured user data is successful in the functional component “HARQ Combine” 520, the writing out of the de-punctured user data is not necessary and BRP continues with the back-end processing for the UE to prepare an ACK for acknowledging the delivery of the user data.

FIG. 13B shows an exemplary diagram illustrating the BRP of a retransmission of user data corresponding to one HARQ process with respect to the single-cached and externally punctured HARQ buffering architecture in FIG. 12. The current HS-PDSCH reception is a retransmission of user data corresponding to the current HARQ process from the UTRAN, and the retransmission of the user data is performed using a self-decodable transmission technique in which the systematic bits are always included in each retransmission. After the user data is demodulated, constellation rearranged, and descrambled, the user data comprises 8 systematic bits and 2 sets of 8 parity bits, wherein some of the parity bits are punctured, as shown in FIG. 13B. Subsequently, second de-rate matching is performed and the punctured bits are therefore de-punctured, i.e., filled with soft bits of zeros. Since the current HS-PDSCH reception is a retransmission of a previous unsuccessful delivery of user data, the user data corresponding to the current HARQ process in the last HS-PDSCH reception is read into the HARQ cache 500 from the external memory 510. Particularly, after being read out from the external memory 510 and before being read into the HARQ cache 500, the user data corresponding to the current HARQ process in the last HS-PDSCH reception is de-punctured, i.e., filled with soft bits of zeros, by the de-puncturing unit 1220 according to the de-puncturing parameters previously used in the functional component “2^{nd} De-Rate Matching” 530. After the user data corresponding to the current HARQ process in the last HS-PDSCH reception is read into the HARQ cache 500, the functional component “HARQ Combine” 520 is configured to combine the user data corresponding to the current HARQ process in the current and last HS-PDSCH receptions, and perform CRC on the combined user data. In this embodiment, the CRC procedure on the combined user data fails, and the HARQ cache 500 is configured to write out the combined user data to the external memory 510 via the puncturing unit 1210. During the writing out of the combined user data, the puncturing unit 1210 is configured to puncture the combined user data, i.e., removing the soft bits of zeros filled by the de-puncturing unit, according to the de-puncturing parameters previously used in the functional component “2^{nd} De-Rate Matching” 530. The BRP continues with the back-end processing for the UE to prepare a NACK for negative acknowledgement of the delivery of the user data. In another embodiment, if the CRC procedure on the combined user data is successful in the functional component “HARQ Combine” 520, the writing out of the combined user data is not necessary and the BRP continues with the back-end processing for the UE to prepare an ACK for acknowledging the delivery of the user data.

FIG. 13C shows another exemplary diagram illustrating the BRP of a retransmission of user data corresponding to one HARQ process with respect to the single-cached and externally punctured HARQ buffering architecture in FIG. 12. The current HS-PDSCH reception is a retransmission of user data corresponding to the current HARQ process from the UTRAN, and the retransmission of the user data is performed using a non-self-decodable transmission technique in which only some of the parity bits are included in each retransmission. After the user data is demodulated, constellation rearranged, and descrambled, the user data comprises 2 sets of 8 parity bits, wherein the systematic bits and some of the parity bits are punctured, as shown in FIG. 13C. Subsequently, second de-rate matching is performed and the punctured bits are therefore de-punctured, i.e., filled with soft bits of zeros. Since the current HS-PDSCH reception is a retransmission of a previous unsuccessful delivery of user data, the user data corresponding to the current HARQ process in the last HS-PDSCH reception is read into the HARQ cache 500 from the external memory 510. Particularly, after being read out from the external memory 510 and before being read into the HARQ cache 500, the user data corresponding to the current HARQ process in the last HS-PDSCH reception is de-punctured, i.e., filled with soft bits of zeros, by the de-puncturing unit 1220 according to the de-puncturing parameters previously used in the functional component “2^{nd} De-Rate Matching” 530. After the user data corresponding to the current HARQ process in the last HS-PDSCH reception is read into the HARQ cache 500, the functional component “HARQ Combine” 520 is configured to combine the user data corresponding to the current HARQ process in the current and last HS-PDSCH receptions, and perform CRC on the combined user data. In this embodiment, the CRC procedure on the combined user data fails, and the HARQ cache 500 is configured to write out the combined user data to the external memory 510 via the puncturing unit 1210. During the writing out of the combined user data, the puncturing of the combined user data by the puncturing unit 1210 is skipped as there is no de-punctured bit remaining in the combined user data. The BRP continues with the back-end processing for the UE to prepare a NACK for negative acknowledgement of the delivery of the user data. In another embodiment, if the CRC procedure on the combined user data is successful in the functional component “HARQ Combine” 520, the writing out of the combined user data is not necessary and the BRP continues with the back-end processing for the UE to prepare an ACK for acknowledging the delivery of the user data.

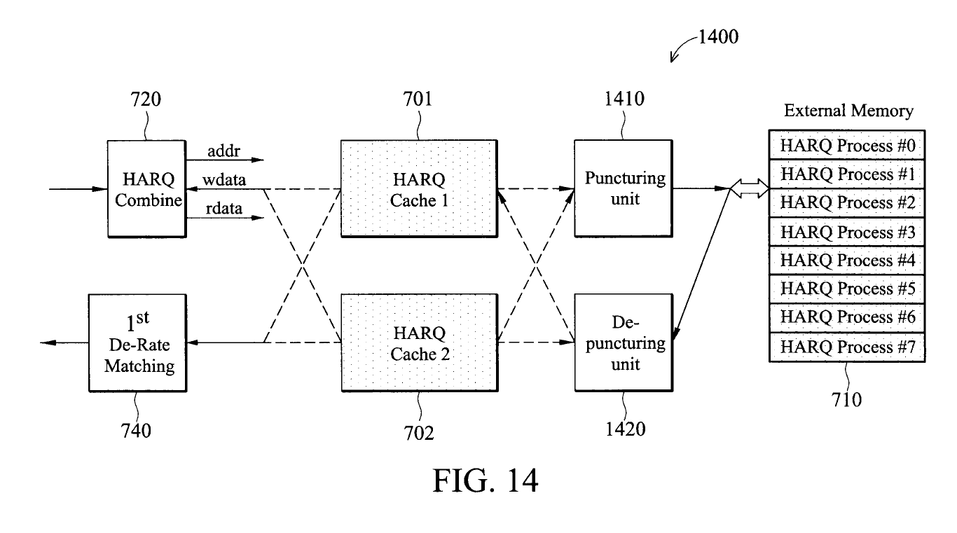

FIG. 14 shows a block diagram illustrating a double-cached and externally punctured HARQ buffering architecture of BRP for a wireless communications device according to an embodiment of the invention. In this embodiment, the wireless communications device may be a UE capable of communicating with a UTRAN according to the HARQ mechanism. Similar to FIG. 7, two HARQ caches 701 and 702 are employed in an HARQ buffering module 1400 for buffering unsuccessful deliveries of user data corresponding to the current and next HARQ processes, respectively, and an external memory 710 is coupled to the HARQ caches 701 and 702 via the AXI bus. Each of the HARQ caches 701 and 702 is in a size of user data corresponding to one HARQ process, and the external memory 710 is partitioned into N separate spaces, denoted as HARQ process #0˜#N−1, for the HARQ processes configured for the HS-DSCH. The number of HARQ processes may be configured to be an integer from 1 to 8 according to the “HARQ info” Information Element (IE) indicated by the UTRAN. The HARQ caches 701 and 702 may be configured to operate in a fixed mode or a ping-pong mode. In the fixed mode, one of the HARQ caches 701 and 702 is configured for writing operations corresponding to the current HARQ process while the other HARQ cache is configured for reading operations corresponding to the next HARQ process. In the ping-pong mode, the HARQ caches 701 and 702 are cyclically configured to perform reading and writing operations requested by the current and next HARQ processes. In addition to the HARQ caches 701 and 702 and the external memory 710, a puncturing unit 1410 and a de-puncturing unit 1420 are employed in the HARQ buffering module 1400 to puncture and de-puncture the unsuccessful delivery of user data between the HARQ caches 701 and 702 and the external memory 710 to be buffered or combined. To further clarify, for the case where the current HS-PDSCH reception is a first transmission of user data corresponding to the current HARQ process from the UTRAN, the functional component “HARQ Combine” 720 performs CRC on the user data. If the CRC procedure fails, the HARQ cache 701 is configured to write the user data corresponding to the current HARQ process to the external memory 710. Note that, during the writing of the user data to the external memory 710, the puncturing unit 1410 is configured to puncture the user data according to the de-puncturing parameters previously used in the functional component “2^{nd} De-Rate Matching” 730.

For the case where the current HS-PDSCH reception is a retransmission of a previous unsuccessful delivery of user data corresponding to the current HARQ process from the UTRAN, the HARQ cache 701 is configured to read in the user data corresponding to the current HARQ process from the last HS-PDSCH reception from the external memory 710 for the HARQ combining procedure. Note that, during the reading of the user data from the external memory 710, the de-puncturing unit 1420 is configured to de-puncture the punctured user data stored in the external memory 710 according to the de-puncturing parameters previously used in the functional component “2^{nd} De-Rate Matching” 730. After the reading of the user data corresponding to the current HARQ process from the last HS-PDSCH reception and the current HS-PDSCH reception are completed, the functional component “HARQ Combine” 720 combines the read and newly received user data and performs CRC on the combined user data. If the CRC procedure on the combined user data fails and the HARQ caches 701 and 702 are operated in the ping-pong mode, the HARQ cache 702 is further configured to write the combined user data to the external memory 710 via the puncturing unit 1410. Moreover, a switching device (e.g. 810 of FIG. 8) may be employed to connect one of the HARQ caches 701 and 702 to one of the functional components “HARQ Combine” 720 and 1^{st} De-Rate Matching” 740, and connect the other HARQ cache to the other function component. A switching device (e.g. 820 of FIG. 8) may be employed to connect one of the HARQ caches 701 and 702 to the external memory 710. Alternatively, two separate switching devices may be employed to connect between the HARQ caches 701 and 702 and the functional components “HARQ Combine” 720 and “1^{st} De-Rate Matching” 740.

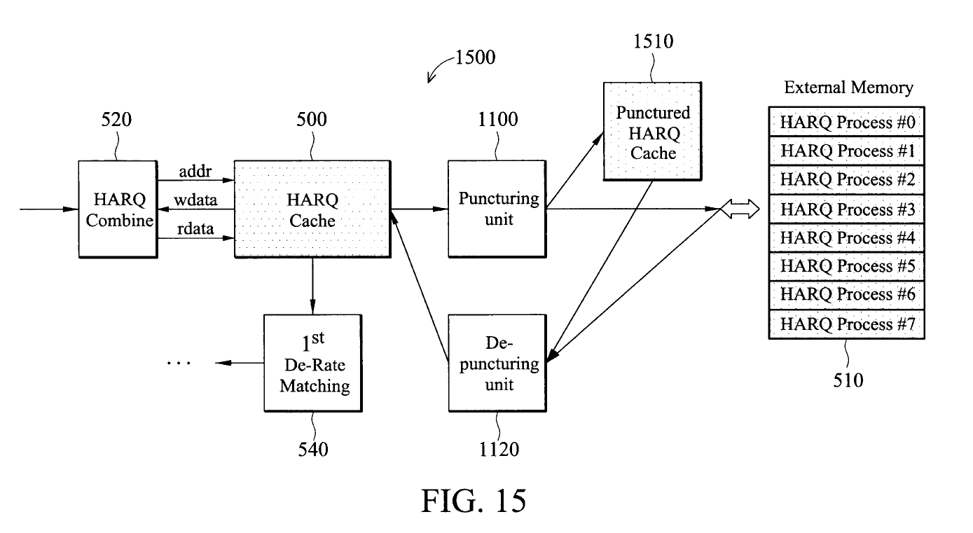

FIG. 15 shows a block diagram illustrating an enhanced single-cached and externally punctured HARQ buffering architecture of BRP for a wireless communications device according to an embodiment of the invention. In this embodiment, the wireless communications device may be a UE capable of communicating with a UTRAN according to the HARQ mechanism. Similar to FIG. 11, in the HARQ buffering module 1500, an HARQ cache 500 equal in size to user data corresponding to an HARQ process is used to buffer user data corresponding to the current or next HARQ process for the functional components “HARQ Combine” 520 and “1^{st} De-Rate Matching” 540, and an external memory 510 is coupled to the HARQ cache 500 via the AXI bus, which is partitioned into N separate spaces, denoted as HARQ process #0˜#N−1, for the HARQ processes configured for the HS-DSCH. The number of HARQ processes may be configured to be an integer from 1 to 8 according to the “HARQ info” Information Element (IE) indicated by the UTRAN. Between the HARQ cache 500 and the external memory 510, a puncturing unit 1110 and a de-puncturing unit 1120 are employed to puncture and de-puncture the unsuccessful delivery of user data to be buffered or combined. In addition to the HARQ cache 500, the external memory 510, the puncturing unit 1110, and the de-puncturing unit 1120, the HARQ buffering module 1500 further comprises a punctured HARQ cache 1510 equal in size to user data corresponding to an HARQ process, which is used as an intermediate storage between the HARQ cache 500 and the external memory 510 to buffer punctured user data corresponding to the specific HARQ process. The employment of the punctured HARQ cache 1510 may reduce the frequency of writing out and reading in the punctured user data to and from the external memory 510. To further clarify, for the case where the current HS-PDSCH reception is a first transmission of user data corresponding to the current HARQ process from the UTRAN, the functional component “HARQ Combine” 520 performs CRC on the user data. If the CRC procedure fails, the HARQ cache 500 is configured to write out the user data corresponding to the current HARQ process. In order to do so, it is first determined whether the punctured HARQ cache 1510 is available for buffering the user data corresponding to the current HARQ process. If the punctured HARQ cache 1510 is available, the HARQ cache 500 is configured to write the user data corresponding to the current HARQ process to the punctured HARQ cache 1510. If the punctured HARQ cache 1510 is not available, the HARQ cache 500 is configured to write the user data corresponding to the current HARQ process to the external memory 510. Note that, during the writing of the user data to the punctured HARQ cache 1510 or the external memory 510, the puncturing unit 1110 is configured to puncture the user data according to the de-puncturing parameters previously used in the functional component “2^{nd} De-Rate Matching” 530. That is, the puncturing step reduces the size of the user data to be stored in the punctured HARQ cache 1510 and the external memory 510.

For the case where the current HS-PDSCH reception is a retransmission of a previous unsuccessful delivery of user data corresponding to the current HARQ process from the UTRAN, the HARQ cache 500 is configured to read in the user data corresponding to the current HARQ process from the last HS-PDSCH reception for the HARQ combining procedure. In order to do so, it is first determined whether the user data corresponding to the current HARQ process from the last HS-PDSCH reception is buffered in the punctured HARQ cache 1510. If so, the HARQ cache 500 is configured to read in the user data corresponding to the current HARQ process from the last HS-PDSCH reception from the punctured HARQ cache 1510. Otherwise, the HARQ cache 500 is configured to read in the user data corresponding to the current HARQ process from the last HS-PDSCH reception from the external memory 510. Note that, during the reading of the user data from the external memory 510, the de-puncturing unit 1120 is configured to de-puncture the punctured user data stored in the punctured HARQ cache 1510 or the external memory 510 according to the de-puncturing parameters previously used in the functional component “2^{nd} De-Rate Matching” 530. After the reading of the user data corresponding to the current HARQ process from the last HS-PDSCH reception and the current HS-PDSCH reception are completed, the functional component “HARQ Combine” 520 combines the read and newly received user data, and performs CRC on the combined user data. If the CRC procedure on the combined user data fails, the HARQ cache 500 is further configured to write out the combined user data. Specifically, it is first determined whether the punctured HARQ cache 1510 is available for buffering the combined user data corresponding to the current HARQ process or it is first determined whether the user data corresponding to the current HARQ process from the last HS-PDSCH reception is already buffered in the punctured HARQ cache 1510. If so, the HARQ cache 500 is configured to overwrite the punctured HARQ cache 1510 with the combined user data. Otherwise, the HARQ cache 500 is configured to write the combined user data to the external memory 510. Likewise, during the writing of the combined user data to the punctured HARQ cache 1510 or the external memory 510, the puncturing unit 1110 is configured to puncture the user data according to the de-puncturing parameters previously used in the functional component “2^{nd} De-Rate Matching” 530. Note that the size of the HARQ cache 500 equals to that of user data corresponding to one HARQ process, and the sizes of the punctured HARQ cache 1510 and each partition in the external memory 510 are smaller in size than that of a de-punctured user data corresponding to one HARQ process. Regarding the detailed operations of the HARQ buffering for other cases of HS-PDSCH reception, references may be made to the descriptions with respect to the FIG. 6. Alternatively, the size of the HARQ cache 500 may equal to that of data corresponding to more than one HARQ process.

Regarding the detailed descriptions of the functional components shown in FIGS. 11, 12, 14, and 15, such as “De-modulation”, “Constellation Rearrangement”, “De-interleaving”, “De-scrambling”, “2^{nd} De-Rate Matching”, “HARQ Combine”, “1^{St} De-Rate Matching”, “Turbo Decoder”, “CRC”, “Front-end Sequencer”, and “Back-end Sequencer”, references may be made to the 3GPP TS 25.221 specification. The above mentioned functional components may be implemented with program codes which is stored in another memory (not shown) or a storage device (not shown), and is loaded and executed by a processing unit, such as a general-purposed processor or a micro-control unit (MCU), or others, to provide the specific functionalities. In addition to the functional components shown in FIGS. 11, 12, 14, and 15, the wireless communications device may further comprise a wireless communications module (not shown) for receiving wireless signals which carry the HS-SCCH and HS-PDSCH associated data from the UTRAN, and transmitting wireless signals which carry the HS-SICH associated data to the UTRAN, as described above with respect to FIG. 5.

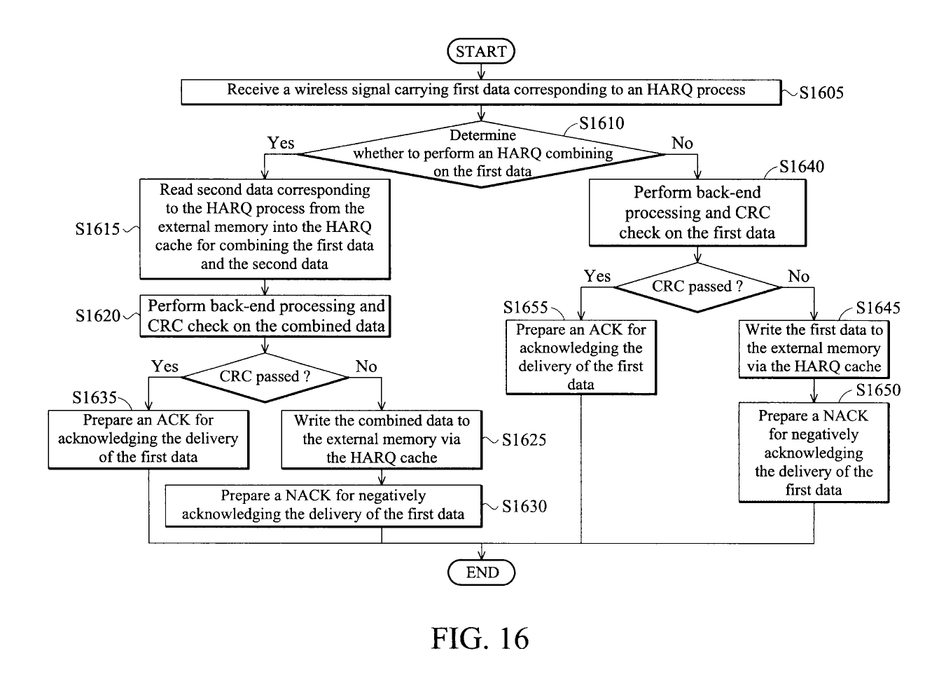

FIG. 16 shows a flow chart illustrating an HARQ buffering method utilized for the single-cached HARQ buffering architecture in FIG. 5. The HARQ buffering method may be applied in a wireless communications device capable of wireless communications using the HARQ mechanism, and the goal of the HARQ buffering method is to reduce the cost of HARQ buffering. To begin the BRP, the wireless communications device receives from a cellular network a wireless signal carrying first data corresponding to an HARQ process (step S1605). Subsequently, the wireless communications device determines whether to perform an HARQ combining procedure on the first data (step S1610). In response to performing the HARQ combining procedure, the wireless communications device reads second data corresponding to the HARQ process from the external memory 510 into the HARQ cache 500 for combining the first data and the second data (step S1615), wherein the second data is received from the last HS-PDSCH reception for the HARQ process. After the HARQ combining procedure is completed, the wireless communications device performs back-end processing (De-Rate matching, turbo decoding) and CRC check on the combined data (step S1620). In response to unsuccessful results of the CRC procedure performed on the combined data, the combined data is written to the external memory 510 via the HARQ cache 500 (step S1625). After that, the BRP continues with the back-end processing for the wireless communications device to prepare a NACK for negative acknowledgement of the delivery of the first data (step S1630). In response to successful results of the CRC procedure performed on the combined data, the wireless communications device prepares an ACK for acknowledging the delivery of the first data (step S1635). Subsequent to the step S1610, in response to not performing the HARQ combining procedure, the wireless communications device performs back-end processing (De-Rate matching, turbo decoding) and CRC check on the first data (step S1640). In response to unsuccessful results of the CRC procedure performed on the first data, the wireless communications device writes the first data to the external memory 510 via the HARQ cache 500 (step S1645). The BRP continues with the back-end processing for the wireless communications device to prepare a NACK for negative acknowledgement of the delivery of the first data (step S1650). In response to successful results of the CRC procedure performed on the first data, the wireless communications device prepares an ACK for acknowledging the delivery of the first data (step S1655). Note that the HARQ buffering method may be utilized for the single-cached and internally punctured HARQ buffering architecture in FIG. 11, except that, in step S1615, the second data stored in the internal memory 1130 is punctured and needs to be de-punctured before the HARQ combining procedure, and in steps S1625 and S1635, the combined data and the first data need to be punctured before being written to the internal memory 1130. Likewise, the HARQ buffering method may be utilized for the single-cached and externally punctured HARQ buffering architecture in FIG. 12, except that, in step S1615, the second data stored in the external memory 510 is punctured and needs to be de-punctured before the HARQ combining procedure, and in steps S1625 and S1635, the combined data and the first data need to be punctured before being written to the external memory 510.

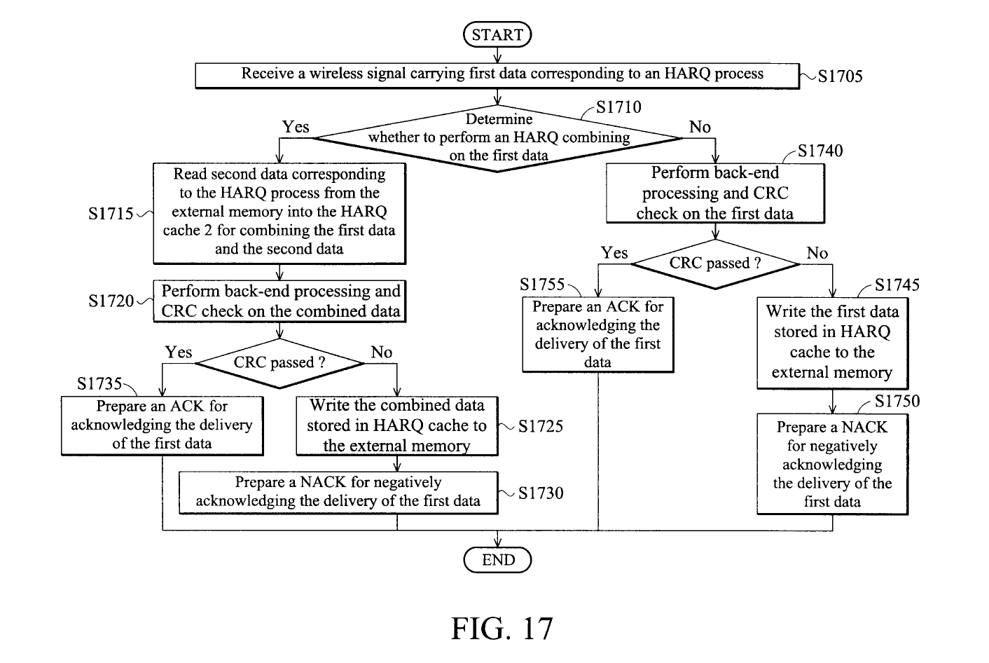

FIG. 17 shows a flow chart illustrating an HARQ buffering method utilized for the double-cached HARQ buffering architecture in FIG. 7. The HARQ buffering method may be applied in a wireless communications device capable of wireless communications using the HARQ mechanism, and the goal of the HARQ buffering method is to reduce the cost of HARQ buffering. The HARQ caches 701 and 702 are configured to operate in ping-pong mode, in which the HARQ caches 701 and 702 are instead cyclically configured to perform the reading and writing operations required for the current and next HARQ processes. To begin the BRP, the wireless communications device receives from a cellular network a wireless signal carrying first data corresponding to an HARQ process (step S1705). Subsequently, the wireless communications device determines whether to perform an HARQ combining procedure on the first data (step S1710). In response to performing the HARQ combining procedure, the wireless communications device reads second data corresponding to the HARQ process from the external memory 710 into the HARQ cache 702 for combining the first data and the second data (step S1715), wherein the second data is received from the last HS-PDSCH reception for the HARQ process. After the HARQ combining procedure is completed, the wireless communications device performs back-end processing (De-Rate matching, turbo decoding) and CRC check on the combined data (step S1720). In response to unsuccessful results of the CRC procedure performed on the combined data, the combined data stored in HARQ cache 702 is written to the external memory 710 (step S1725). The BRP continues with the back-end processing for the wireless communications device to prepare a NACK for negative acknowledgement of the delivery of the first data (step S1730). In response to successful results of the CRC procedure performed on the combined data, the wireless communications device prepares an ACK for acknowledging the delivery of the first data (step S1735).

Subsequent to the step S1710, in response to not performing the HARQ combining procedure, the wireless communications device performs back-end processing (De-Rate matching, turbo decoding) and CRC check on the first data (step S1740). In response to unsuccessful results of the CRC procedure performed on the first data, the wireless communications device writes the first data stored in HARQ cache 702 to the external memory 710 (step S1745). The wireless communications device then prepares a NACK for negative acknowledgement of the delivery of the first data (step S1750). In response to successful results of the CRC procedure performed on the first data, the BRP continues with the back-end processing for the wireless communications device to prepare an ACK for acknowledging the delivery of the first data (step S1755). After that, the method ends or the flow circles back to the step S1705 for receiving subsequent data. Note that the HARQ buffering method may be utilized for the double-cached and externally punctured HARQ buffering architecture in FIG. 14, except that, in step S1715, the second data stored in the external memory 710 is punctured and needs to be de-punctured before the HARQ combining procedure, and in steps S1725 and S1735, the combined data and the first data need to be punctured before being written to the external memory 710. The ping-pong mode is like a multi-thread concept, while step S1715 of sub-frame N+1 may be executed with step S1725 or S1745 of sub-frame N. In addition, the HARQ buffering method may be utilized for the double-cached HARQ buffering architecture with the HARQ caches operating in a fixed mode, in which the HARQ cache 701 is used for the writing operation corresponding to the current HARQ process while the HARQ cache 702 is used for the reading operation corresponding to the next HARQ process, and those skilled in the art may contemplate modifications to the flow of the HARQ buffering method according to the descriptions with respect to FIGS. 7, 10, 17.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). For example, the functional components of the BRP architectures in FIGS. 5 and 7 may each be implemented in program code stored in a machine-readable storage medium, such as a magnetic tape, semiconductor, magnetic disk, optical disc (e.g., CD-ROM, DVD-ROM, etc.), or others, and when loaded and executed by a processing unit or an MCU, the program code may perform the HARQ buffering methods in FIGS. 16 and 17. Although the embodiments described above employ the TD-SCDMA based technology, the invention is not limited thereto. The embodiments may also be applied to other wireless technologies, such as WCDMA, LTE, and WiMAX technologies. Therefore, the scope of the appended claims should be accorded the broadest interpretation so as to encompass all such modifications and similar arrangements.

1. A wireless communications device, comprising:
a first cache unit coupled to a memory unit;
a wireless communications module receiving from a cellular network a wireless signal carrying first data corresponding to a hybrid automatic repeat request (HARQ) process;
an HARQ combine component, coupled to the first cache unit, reading second data corresponding to the HARQ process from the memory unit into the first cache unit, and combining the first data and the second data for an HARQ combining procedure.

2. The wireless communications device as claimed in claim 1, wherein the HARQ combine component further performs a cyclic redundancy checking (CRC) procedure on the combined data, and writing the combined data to the memory unit after the CRC procedure.

3. The wireless communications device as claimed in claim 2, wherein the writing of the combined data to the memory unit is performed in response to unsuccessful results of the CRC procedure performed on the combined data.

4. The wireless communications device as claimed in claim 3, wherein the wireless communications module further transmits to the cellular network another wireless signal, carrying negative acknowledgement (NACK) information in response to the unsuccessful results of the CRC procedure performed on the combined data, or carrying acknowledgement (ACK) information in response to successful results of the CRC procedure performed on the combined data.

5. The wireless communications device as claimed in claim 2, wherein the memory unit is an off-chip or off-die memory and coupled to the first cache unit by a bus.

6. The wireless communications device as claimed in claim 2, further comprising a second cache unit coupled to the memory unit, wherein the HARQ combine component further writes third data corresponding to another HARQ process to the memory unit via the second cache unit after performing the CRC procedure on the third data.

7. The wireless communications device as claimed in claim 6, wherein the writing of the third data to the memory unit is performed in response to unsuccessful results of the CRC procedure performed on the third data.

8. The wireless communications device as claimed in claim 6, wherein the HARQ combine component further alternates between the first cache unit and the second cache unit for performing the reading and writing of data from and to the memory unit.

9. The wireless communications device as claimed in claim 2, wherein the first data is de-punctured according to at least one first de-puncturing parameter prior to the combination with the second data.

10. The wireless communications device as claimed in claim 9, further comprising a de-puncturing unit, coupled between the cache unit and the memory, de-puncturing the second data according to at least one second de-puncturing parameter before the second data is read into the first cache unit.

11. The wireless communications device as claimed in claim 6, wherein the first data is de-punctured according to at least one first de-puncturing parameter prior to the combination with the second data, and the third data is de-punctured according to at least one third de-puncturing parameter prior to performing the CRC procedure on the third data.

12. The wireless communications device as claimed in claim 11, further comprising:
a puncturing unit, coupled between the first cache unit and the memory, and between the second cache unit and the memory, puncturing the combined data and the third data before the combined data and the third data are written to the memory unit; and
a de-puncturing unit, coupled between the first cache unit and the memory, and between the second cache unit and the memory, de-puncturing the second data before the second data is read into the first cache unit.

13. A wireless communications device, comprising:
a cache unit coupled to a memory unit;
a wireless communications module receiving from a cellular network a wireless signal carrying data corresponding to a hybrid automatic repeat request (HARQ) process;
a HARQ combine component, coupled to the first cache unit, writing the data to the memory unit via the cache unit.

14. The wireless communications device as claimed in claim 13, wherein the writing of the data to the memory unit is performed in response to unsuccessful results of a cyclic redundancy checking (CRC) procedure performed on the data.

15. The wireless communications device as claimed in claim 13, wherein the wireless communications module further transmits to the cellular network another wireless signal, carrying negative acknowledgement (NACK) information in response to the unsuccessful results of the CRC procedure performed on the data.

16. The wireless communications device as claimed in claim 13, further comprising a puncturing unit, coupled between the cache unit and the memory unit, puncturing the data before the data is written to the memory unit.

17. The wireless communications device as claimed in claim 13, wherein the memory is an off-chip or off-die memory and coupled to the cache unit by a bus.

18. A method for HARQ buffering optimization in a wireless communications device, comprising:
receiving from a cellular network a wireless signal carrying first data corresponding to a hybrid automatic repeat request (HARQ) process;
reading second data corresponding to the HARQ process from an off-chip or off-die memory unit into a first cache unit; and
combining the first data and the second data for an HARQ combining procedure.

19. The method as claimed in claim 18, further comprising:
performing a cyclic redundancy checking (CRC) procedure on the combined data; and
writing the combined data to the off-chip or off-die memory unit via the first cache unit after the CRC procedure.

20. The method as claimed in claim 19, wherein the writing of the combined data to the off-chip or off-die memory unit is performed in response to unsuccessful results of the CRC procedure.

21. The method as claimed in claim 20, further comprising:
transmitting to the cellular network another wireless signal, carrying negative acknowledgement (NACK) information in response to the unsuccessful results of the CRC procedure performed on the first data, or carrying acknowledgement (ACK) information in response to successful results of the CRC procedure performed on the first data.

22. The method as claimed in claim 19, further comprising writing third data corresponding to another HARQ process to the off-chip or off-die memory unit via a second cache unit after performing the CRC procedure performed on the third data.

23. The method as claimed in claim 22, wherein the writing of the third data to the off-chip or off-die memory unit is performed in response to unsuccessful results of the CRC procedure performed on the third data.

24. The method as claimed in claim 22, further comprising alternating between the first cache unit and the second cache unit for performing the reading and writing of data from and to the off-chip or off-die memory unit.

25. The method as claimed in claim 19, wherein the first data is de-punctured according to at least one first de-puncturing parameter prior to the combination with the second data.

26. The method as claimed in claim 25, further comprising puncturing the first data according to the first de-puncturing parameter before writing the first data to the off-chip or off-die memory unit via the first cache unit, and de-puncturing the second data according to at least one second de-puncturing parameter before the second data is read into the first cache unit.

27. The method as claimed in claim 23, wherein the first data is de-punctured according to at least one first de-puncturing parameter prior to the combination with the second data, and the third data is de-punctured according to at least one third de-puncturing parameter prior to performing the CRC procedure on the third data.

28. The method as claimed in claim 27, further comprising:
puncturing the first data before the first data is written to the off-chip or off-die memory unit via the first cache unit;
de-puncturing the second data before the second data is read into the first cache unit; and
puncturing the third data before the third data is written to the off-chip or off-die memory unit via the second cache unit.
